(19) United States
(12) Patent Application Publication
(10) Pub. No.: US 2009/0089094 A1
(43) Pub. Date: Apr. 2, 2009

(54) SYSTEM AND METHOD FOR DETECTION OF ABUSE OF PATIENT DATA

(75) Inventors: Matthew Sweeney Stockton, Milwaukee, WI (US); Lorinc Hever, Wauwatosa, WI (US)

Correspondence Address: GE HEALTHCARE;c/o FLETCHER YODER, PC, P.O. BOX 692289, HOUSTON, TX, 77269-2289, US

(73) Assignee: General Electric Company, Schenectady, NY (US)

(21) Appl. No.: 11/863,402

(22) Filed: Sep. 28, 2007

(51) Int. Cl. G06Q 50/00; G06F 17/30

(52) U.S. Cl. 705/3

(57) ABSTRACT

A technique for detecting abuse of protected health information stored in a medical information system is presented. A record of each user's access to the protected health information is created and stored. The record of the access is configured to provide a basis for determining whether a user's access to the protected health information was for a legitimate reason or was a possible abuse of a patient's protected health information. A data mining program is used to search the records of access to the protected health information and identify possible abuses of patients protected health information. When a possible abuse of a patient's protected health information is identified as a result of the data mining, an alert is sent to notify a responsible authority of a possible abuse of a patient's protected health information.

### BACKGROUND

The invention relates generally to medical information systems. In particular, the invention relates to medical information systems operable to store and transmit protected health information.

The Health Insurance Portability and Accountability Act (“HIPAA”) set forth standards for the electronic exchange, privacy and security of health information. HIPAA protects all “individually identifiable health information” held or transmitted by a covered entity or its business associate, in any form or media, whether electronic, paper, or oral. The U.S. Department of Health and Human Services issued: “The Standards for Privacy of Individually Identifiable Health Information” (“Privacy Rule”) to establish, for the first time, a set of national standards for the protection of certain health information. The U.S. Department of Health and Human Services issued the Privacy Rule to implement the requirements of HIPAA. The Privacy Rule standards address the use and disclosure of individuals' health information by organizations subject to the Privacy Rule, as well as standards for individuals' privacy rights to understand and control how their health information is used.

The Privacy Rule protects all “individually identifiable health information” held or transmitted by a covered entity to its business associate, in any form or media, whether electronic, paper, or oral. “Individually identifiable health information” is information, including demographic data, that relates to: the individual's past, present, or future physical or mental health or condition, the provision of health care to the individual, or the past, present, or future payment for the provisions of health care to the individual and that identifies the individual for which there is a reasonable basis to believe can be used to identify the individual. Individually identifiable health information includes many common identifiers (e.g. name, address, birth date, Social Security Number). The Privacy Rule calls this information “protected health information.”

A major goal of the Privacy Rule is to assure that individuals' protected health information is properly protected while allowing the flow of health information needed to provide and promote high quality health care and to protect the public's health and well being. The Privacy Rule strikes a balance that permits important uses of information, while protecting the privacy of people who seek care and healing. Given that the health care marketplace is diverse, the Privacy Rule is designed to be flexible and comprehensive to cover the variety of uses and disclosures that need to be addressed.

A major purpose of the Privacy Rule is to define and limit the circumstances in which an individual's protected heath information may be used or disclosed by covered entities. A covered entity may not use or disclose protected health information, except either: (1) as the Privacy Rule permits or requires; or (2) as the individual who is the subject of the information (or the individual's personal representative) authorizes in writing. A covered entity must disclose protected health information in only two situations: (a) to individuals (or their personal representatives) specifically when they request access to, or an accounting of disclosures of, their protected health information; and (b) to HHS when it is undertaking a compliance investigation or review or enforcement action. A covered entity is permitted, but not required, to use and disclose protected health information, without an individual's authorization, for the following purposes or situations: (1) to the individual (unless required for access or accounting of disclosures); (2) treatment, payment, and health care operations; (3) opportunity to agree or object; (4) incident to an otherwise permitted use and disclosure; (5) public interest and benefit activities; and (6) limited data set for the purpose of research, public health or health care operations. A covered entity must obtain the individual's written authorization for any use or disclosure of protected health information that is not for treatment, payment or health care operations or otherwise permitted or required by the Privacy Rule.

A covered entity must maintain reasonable and appropriate administrative, technical, and physical safeguards to prevent intentional or unintentional use or disclosure of protected health information in violation of the Privacy Rule and to limit its incidental use and disclosure pursuant to otherwise permitted or required use or disclosure. In large organizations, such as hospitals, protected health information is stored in an information system that can be accessed by a large number of users. This has the benefit of enabling healthcare workers to access the information quickly and easily for diagnosis and treatment. However, the ease of access to protected health information for committed healthcare workers also makes safeguards to prevent the disclosure of protected health information more difficult because the ease of access provided by an information system makes it easier for the nefarious to gain access to a patient's protected health information.

Unfortunately, even authorized healthcare professionals have been known to abuse a patient's protected health information. For example, an authorized healthcare professional may access the information system to look for the protected health information of a celebrity or VIP for curiosity, to publicly disclose in an attempt to embarrass them, or to sell to a tabloid. In this scenario, password protection is insufficient to prevent the protected health information from being abused because the abuse would be caused by a user authorized to access the information and who could also, presumably, provide the required password.

When an incident of abuse of protected health information becomes known publicly, it may be possible to investigate the abuse and identify the person responsible for the abuse of the protected health information. However, this is only possible after the abuse of protected health information has become known publicly. By then, the damage has been done to the patient.

Therefore, a need exists for a proactive technique to identify possible abuses of protected health information. In addition, a need exists for a technique to detect a possible abuse of protected health information by a person authorized to access the information. Furthermore, a need exists for a technique to detect a potential abuse of protected health information before the actual abuse can occur.

### BRIEF DESCRIPTION

A technique for detecting abuse of protected health information stored in a medical information system is presented. Whenever a user accesses protected health information, a record of the access is stored. The record of the access is configured to provide a basis for determining whether the user's access of the protected health information is for legitimate reasons or is a possible abuse of the protected health information. The record may include the name of the patient, the name of the user accessing the protected health information, the location of the user accessing the protected health information, the date and time that the user accessed the protected health information, the nature of the protected health information, the search terms used to identify the protected health information, etc.

A data mining program is used to search the records of access to the protected health information and identify possible abuses of patients protected health information. An administrator may input the rules by which the access records are mined. When a possible abuse of a patient's protected health information is identified as a result of the data mining, an alert is sent to notify a responsible authority that a possible abuse of a patient's protected health information is occurring or has occurred.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic drawing of a medical information system, in accordance with an exemplary embodiment of the present technique;

FIG. 2 is a block diagram of a technique for preventing the abuse of protected health information both by persons not authorized to access the information and those authorized to access the information, in accordance with an exemplary embodiment of the present technique;

FIG. 3 is an example of an audit record of access to protected health information, in accordance with an exemplary embodiment of the present technique;

FIG. 4 is a representative list of audit log data mining rules for the system of FIG. 1, in accordance with an exemplary embodiment of the present technique; and

FIG. 5 is a representative list of audit log alert rules for the system of FIG. 1, in accordance with an exemplary embodiment of the present technique.

### DETAILED DESCRIPTION

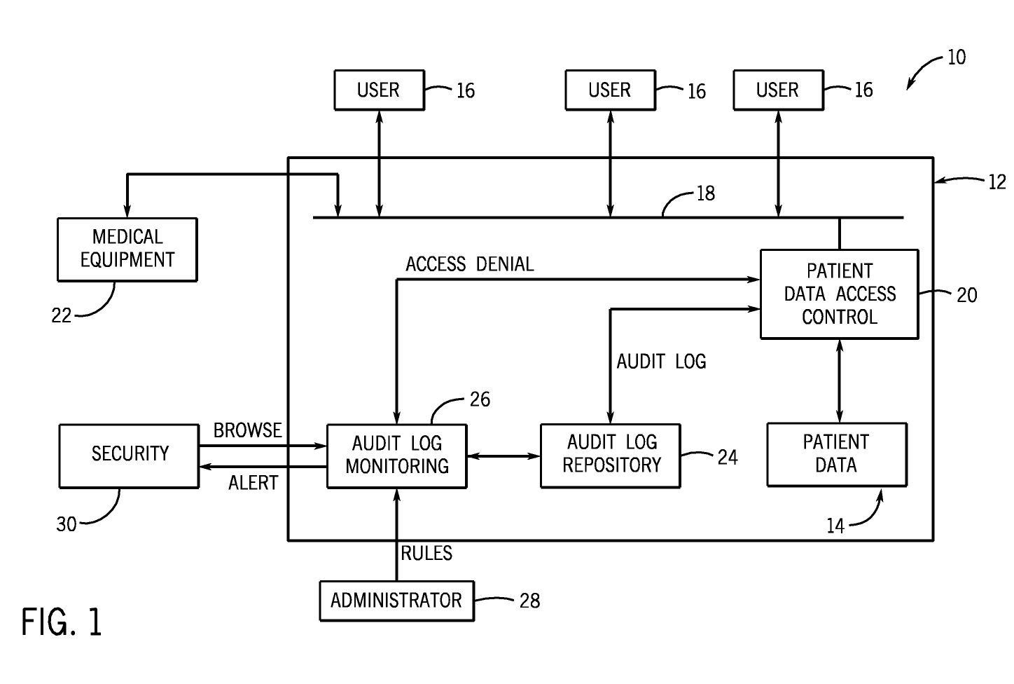

Referring now to FIG. 1, the present invention will be described as it might be applied in conjunction with an exemplary system for storing and protecting protected health information, represented generally by reference numeral 10. However, the techniques described herein can be used in a myriad of different information systems.

In the illustrated embodiment, the system 10 for storing and protecting protected health information includes a medical information system, represented generally by reference numeral 12. In the illustrated embodiment, the medical information system 12 utilizes database and application servers to operate the medical information system 12 and to store and transmit data. However, other devices may be used. In this embodiment, protected health information is stored in a patient database 14 within the medical information system 12. The protected health information includes demographic data, that relates to: the individual's past, present, or future physical or mental health or condition, the provision of health care to the individual, or the past, present, or future payment for the provisions of health care to the individual and that identifies the individual for which there is a reasonable basis to believe can be used to identify the individual and includes many common identifiers (e.g., name, address, birth date, Social Security Number). Alternatively, the protected health information may be stored across several platforms, not just a single database.

The system 10 also comprises a network represented generally by reference numeral 18, to enable users 16 to communicate with the medical information system 12. The network 18 may be the Internet, a local area network (LAN), or some other type of network. In the illustrated embodiment, users 16 can access the patient database 14 via the network 18. In addition to enabling a user to access protected health information in the patient database 14, the network 18 also enables a user to input protected health information into the patient database 14. However, the technique may also be used without a network, such as with a single computer.

In this embodiment of the system 10, access to the patient data is controlled by a patient data access control application 20. The patient data access control application 20 serves as a gatekeeper to prevent unauthorized users from accessing the patient data within the patient database 14. For example, the patient data access control application 20 may require a user 16 to provide a required password before allowing the user 16 to access the protected health information within the patient database 14. The patient data access control application 20 can also be used to direct protected health information to the patient database 14 from various types of medical equipment 22. For example, digital images can be sent from a digital medical imaging system to the patient database 14 for storage and later retrieval via the patient data access control application 20. Alternatively, the technique could be used in the digital medical imaging system.

In the illustrated embodiment, an audit log is generated whenever a user accesses protected health information within the patient database 14. The audit log is a record of a user's access to a patient's protected health information. In particular, the audit log records information that can enable the system 10 to determine what protected health information was accessed, who accessed it, and the process by which they accessed the information. The audit log may include such information as the patient's name and identification number, the type of protected health information accessed, the user's name and identification number, the time and date of the access, the destination computer, and any query information used to search for a patient's protected health information. The audit logs are stored in an audit log repository 24

An audit log monitoring application 26 automatically monitors the audit logs in the audit log repository 24 for suspected abuse of protected health information. In the illustrated embodiment, the audit log monitoring application 26 engages in data mining of the audit logs in the audit log repository 24. In addition, the audit log monitoring application 26 is connected to the network 18 to enable it to access additional information, such as an employee database. In this embodiment, the patient database 14, the patient data access control 20, the audit log repository 24, and the audit log monitoring application 26 are shown as part of a single medical information system 12. However, they may be dispersed among different information systems, servers, or computers.

An administrator 28 provides the audit log monitoring application 26 with the rules to guide the data mining operations. The rules are adapted to identify circumstances when a user's behavior in accessing protected health information could be indicative of an abuse of one or more patients protected health information.

In the illustrated embodiment, when a data mining operation performed by the audit log monitoring application 26 establishes that a possible abuse of a patient's protected health information has occurred, as defined by the rules, an alert is sent to security 30. In addition, the audit log monitoring application 26 may be programmed to send an instruction to the patient data access control application 20 to deny access to a user 16 identified as a possible abuser of a patient's protected health information. Furthermore, security 30 can also browse the audit log repository 24 directly to query or review the audit logs in the audit log repository 24. If a violation or questionable activity is uncovered by security, access to the patient database 14 can be denied to the offending user 16.

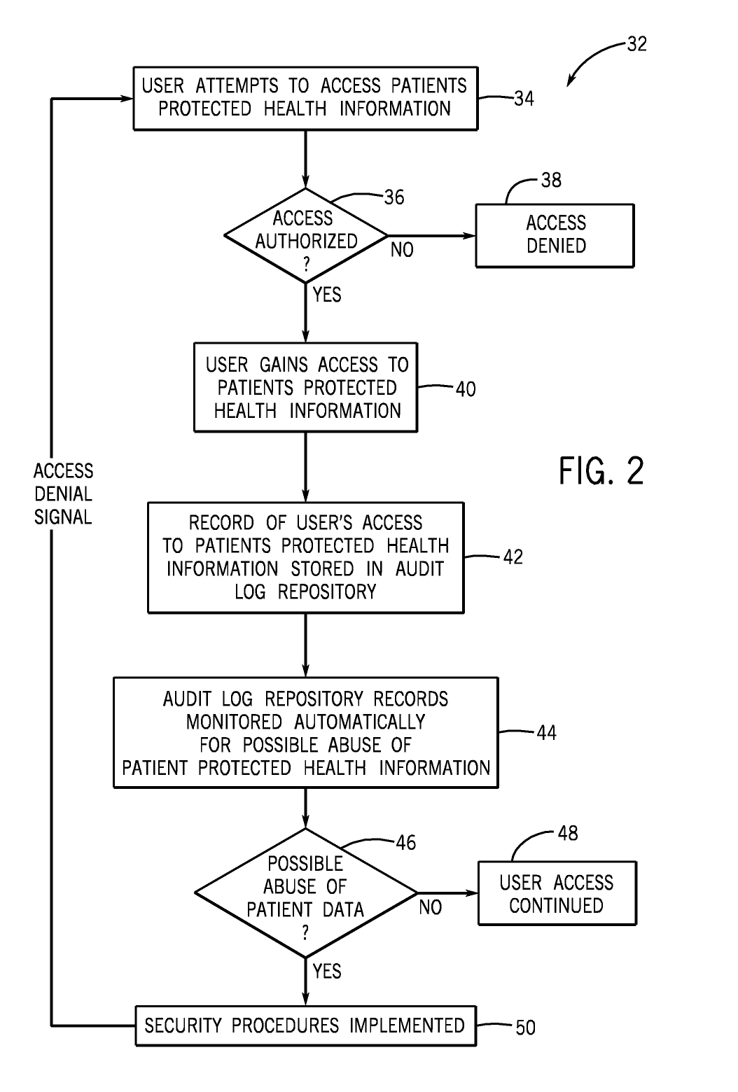

Referring generally to FIGS. 1 and 2, a technique for protecting protected health information stored in the medical information system 12 from abuse is presented, and represented generally by reference numeral 32. The technique tries to strike a balance that permits important uses of protected health information, while protecting the privacy of people who seek care and healing. The technique is described below as would be used by the system 10 of FIG. 1. However, the technique may be used in systems other than the system 10 of FIG. 1.

In this embodiment of the technique 32, a user 16 initially attempts to access the protected health information, represented generally by block 34. A user must be authorized to access protected health information before access to the protected health information is enabled. In the illustrated embodiment, the system performs an initial verification check to determine whether or not the user 16 is authorized to access the protected health information, represented generally by block 36. In this embodiment, the names of authorized users along with their corresponding user identifications and passwords are stored in the medical information system 12. To gain access to the protected health information, a user 16 must provide the user identification and password corresponding to an authorized user. The patient data access control 20 is used to determine if the user identification and password match an authorized user's user identification and password stored within the system 10. If the patient data access control application 20 determines that the user 16 is not authorized to access protected health information, access to the protected health information is denied, represented by block 38. This event will also create an audit record which can be used in the data mining. On the other hand, if the patient data access control application 20 determines that the user 16 is authorized to access protected health information, access to the protected health information is allowed and the user 16 will gain access to the protected health information stored in the patient database 14, represented by block 40.

As noted above, whenever a user 16 accesses protected health information, an audit log of the access is created and stored in the audit log repository, represented generally by block 42. Information regarding the user's access to the protected health information is stored in the audit log to enable the system 10 to determine if the protected health information is being abused by a user 16. The audit log may include such information as the patient's name and identification number, the patient's primary care physician, or any other physician assigned to the patient's care, the user's name and identification number, the time and date of the access, the user's computer, any query information, image numbers, etc. The information can also be used to determine if an unauthorized user has hacked into the medical information system 12.

In this embodiment, potential abuses of the protected health information are identified by data mining the audit logs in the audit log repository 24 using the audit log monitoring application 26, represented generally by block 44. Data mining involves sorting through large amounts of data and picking out relevant information. In the illustrated embodiment, the access data in the audit logs stored in the audit log repository 24 are data mined based on rules established by the administrator 28.

The data mining rules are adapted to identify user activities in accessing protected health information in the patient database 14 that are indicative of a possible abuse of protected health information. The rules are designed to identify subtle abuses of a patient's protected health information, as well as more obvious abuses of a patient's protected health information. In addition, the rules are designed to identify a possible abuse of a patient's protected health information occurring from a single access by a user to a patient's protected health information, such as attempting to access a celebrity's protected health information, as well as by examining a user's behavior in accessing the protected health information of one or more patient's over a period of time.

The audit log monitoring application 26 determines if a user's access to a patient's protected health information is a possible abuse of the patient's protected health information, represented generally by block 46. If, as a result of the data mining, the audit log monitoring application 26 does not identify any audit logs that may be evidence of a possible abuse of the patient's protected health information, the user may continue to have access to the protected health information, represented generally by block 48.

If the audit log monitoring application 26 identifies an audit log as containing evidence of a user's possible abuse of a patient's protected health information; security procedures are implemented based on alert rules programmed into the audit log monitoring application 26, represented generally by block 50. The alert rules are adapted to protect the patient's protected health information. The alert rules may direct the system to respond to a possible abuse of a patient's protected health information in a variety of ways. A message may be sent from the audit log monitoring application 26 to security 30 to initiate an investigation to determine if the access to the protected health information was, in fact, an abuse of the patient's protected health information. It may be discovered upon investigation that the user's access to the protected health information was for a proper use. The system may be programmed to send a denial of access message from the audit log monitoring application 26 to the patient data access control application 20 to deny the user access to the particular patient's protected health information that the user is suspected of abusing or block the user access to all patients protected health information. Other measures may also be taken when an abuse of a patient's protected health information is indicated.

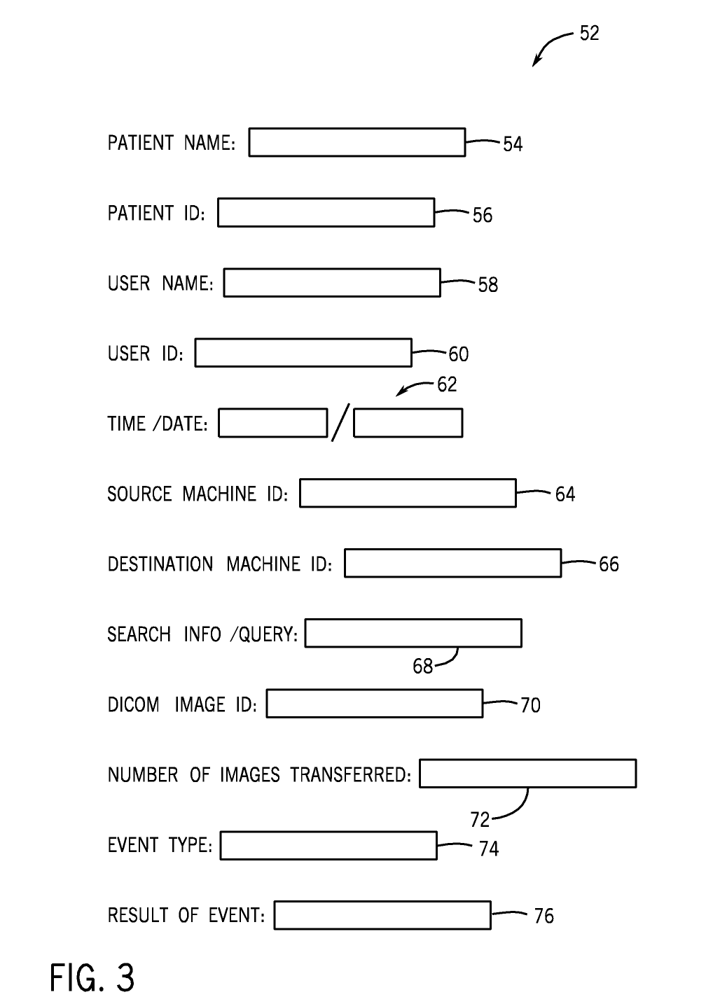

Referring generally to FIG. 3, an exemplary example of an audit log, represented generally by block 52, is presented. An audit log is recorded each time there is an attempt at accessing protected health information. In the illustrated embodiment, the audit log 52 records the name of the patient whose protected health information was accessed, represented generally by reference numeral 54 In addition, an identification number associated with the patient is also recorded, represented generally by reference numeral 56. The name of the user, as represented generally by reference numeral 58, who accessed the protected health information is also recorded. An identification number associated with the user is also recorded, represented generally by reference numeral 60. The data and time that the user accessed the protected health information also is recorded, represented generally by reference numeral 62. An identification number associated with the computer used to access the protected health information also is recorded, represented generally by reference numeral 64. An identification number associated with the computer used to produce the protected health information also is recorded, represented generally by reference numeral 66. Search/query information also is recorded, represented generally by reference numeral 68. The search/query information is the means and methods used for the data retrieval. It may be the series of actions performed by the user to get to the protected health information, such as mouse clicks, menu selections, etc. It may also be the keywords or logic operators used in the search.

If the protected health information corresponds to a medical image, the image identification number associated with the image also is recorded, represented generally by reference numeral 70. The image identification number may be a DICOM image identification number, or some other medical identification number. DICOM, which is an acronym for Digital Imaging and Communications in Medicine, is a standard for handling, storing, printing, and transmitting information in medical imaging. The DICOM standard includes a file format definition and a network communications protocol. DICOM files can be exchanged between two devices that are capable of receiving image and patient data in the DICOM format, such as scanners, servers, workstations, printers, to create a picture archiving and communication system (PACS). In addition, the number of images transferred also is recorded, represented generally by reference numeral 72.

However, if the protected health information is not a medical image or has another medical identification number, such as a Health Level Seven (HL7) identification number, that identification number may be recorded. HL7 is a standards organization that is accredited by the American National Standards Institute (ANSI). HL7 and its members provide a framework (and related standards) for the exchange, integration, sharing and retrieval of electronic health information. The HL7 standards support clinical practices and the management, delivery, and evaluation of health services. In addition, a number of other Electronic Medical Record (EMR) standards may be used and their identification numbers stored in the audit logs.

The type of action performed also is recorded, such as importing, exporting, security alert, etc., and represented generally by reference numeral 74. Furthermore, the result of the attempted access to protected health information, represented generally by reference numeral 76, is recorded, such as “attempt successful” or “attempt denied”. Additional information may also be recorded in the audit log.

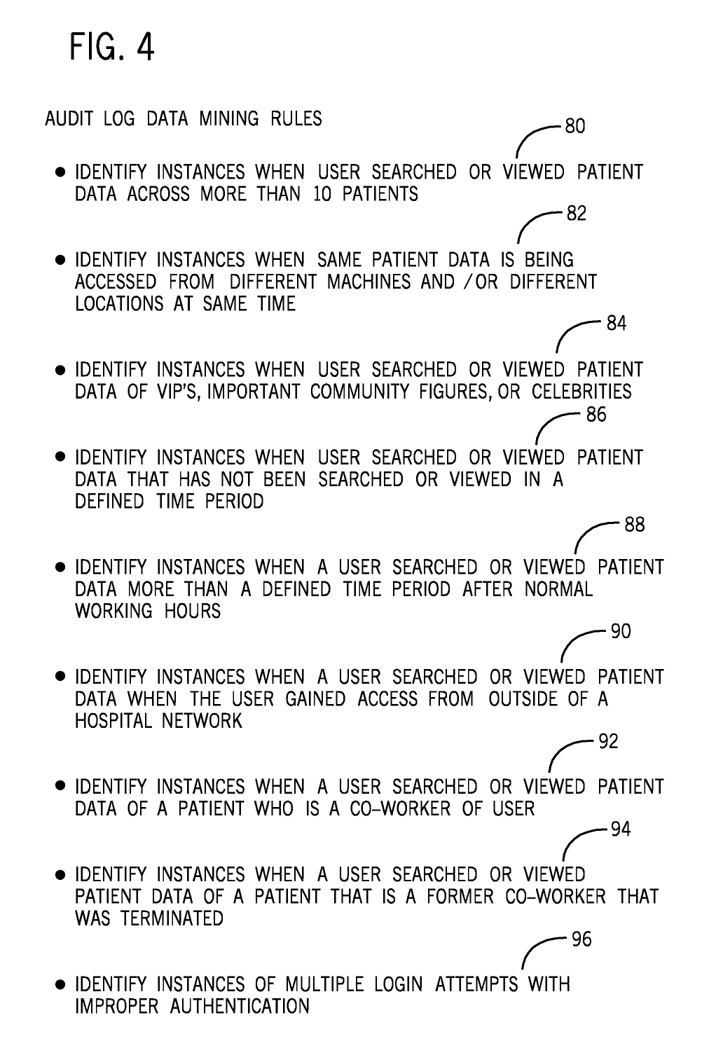

Referring generally to FIG. 4, a non-exclusive list of exemplary examples of audit log mining rules is presented, represented generally by reference numeral 78. The audit log monitoring application 26 can be programmed by the administrator 28. In the illustrated embodiment, the audit log monitoring application 26 is programmed to identify instances when a user 16 searched or viewed protected health information across more than ten patients, represented generally by reference numeral 80, as a possible abuse of protected health information. In addition, the audit log monitoring application 26 can also identify instances when the same protected health information is being accessed from different machines and/or different locations at the same time, represented generally by reference numeral 82. The audit log monitoring application 26 can also identify instances when a user searched or viewed protected health information of VIP's, important community figures, or celebrities, represented generally by reference numeral 84, as a possible abuse of protected health information. In the illustrated embodiment, the audit log monitoring application 26 can also identify instances when a user searched or viewed protected health information that has not been searched or viewed in an extended period of time, such as a year, two years, etc., as a possible abuse of protected health information, represented generally by reference numeral 86. Similarly, the audit log monitoring application 26 can also identify instances when a user searched or viewed protected health information more than a defined period of time after normal working hours, such as three hours, four hours, etc., as a possible abuse of protected health information, represented generally by reference numeral 88. In addition, the audit log monitoring application 26 can also identify instances when a user searched or viewed protected health information when the user gained access from outside of a hospital network as a possible abuse of protected health information, represented generally by reference numeral 90. In the illustrated embodiment, the audit log monitoring application 26 can also identify instances when a user searched or viewed protected health information of a patient who is a co-worker of the user as a possible abuse of protected health information, represented generally by reference numeral 92. Similarly, the audit log monitoring application 26 can also identify instances when a user searched or viewed protected health information of a patient that is a former co-worker that was terminated as a possible abuse of protected health information, represented generally by reference numeral 94. The final example of the audit log data mining rules is that the audit log monitoring application 26 can also be programmed to identify instances of multiple login attempts with improper authentication as a possible abuse of protected health information, represented generally by reference numeral 96.

As mentioned above, the audit log data mining rules described above are not intended to be an exclusive list of audit log data mining rules. For example, an audit log data mining rule may be established to identify instances when a user had attempted to identify patients with specific medical conditions, such as cancer, HIV, mental illness, etc. In addition, an audit log data mining rule may be established to identify instances when a user that had accessed protected health information related to a patients insurance information, such as denial of insurance based on a pre-existing condition, or a patient's employment history or status. In addition, an audit log data mining rule may be established to identify whenever anyone other than a patient's primary care physician, or other designated persons, accesses a patient's protected health information.

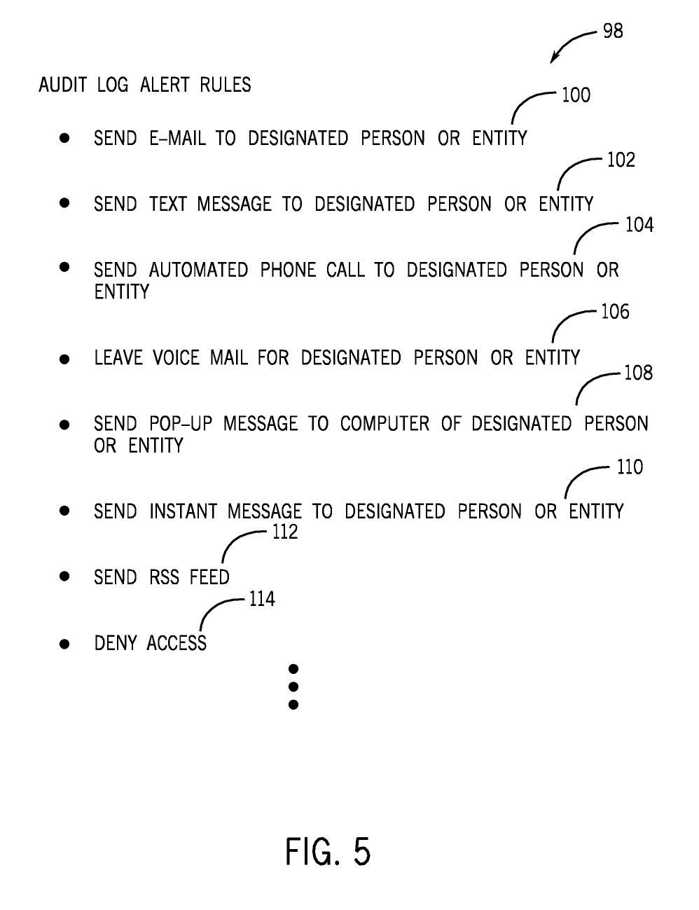

Referring generally to FIG. 5, a non-exclusive list of exemplary examples of audit log alert rules is presented, represented generally by reference numeral 98. When the audit log monitoring application 26 identifies a possible abuse of protected health information, it is programmed to send out a number of different alerts. In the illustrated embodiment, the audit log monitoring application 26 can be programmed by the administrator 28 to send an e-mail to a designated person or entity, such as security 30, when a possible abuse of protected health information is detected, represented generally by reference numeral 100. Similarly, the audit log monitoring application 26 can be programmed to send a text message to a designated person or entity when a possible abuse of protected health information is detected, represented generally by reference numeral 102. The audit log monitoring application 26 can also be programmed to send an automated phone call to a designated person or entity in the event that a possible abuse of protected health information is detected, represented generally by reference numeral 104. Similarly, the audit log monitoring application 26 can also be programmed to leave a voice mail for a designated person or entity in the event that a possible abuse of protected health information is detected, represented generally by reference numeral 106. In addition, the audit log monitoring application 26 can also be programmed to send a pop-up message to the computer of designated person or entity in the event that a possible abuse of protected health information is detected, represented generally by reference numeral 108, or send an instant message to a designated person or entity, represented generally by reference numeral 110. Alternatively, the audit log monitoring application 26 can be programmed to send out an alert as part of an RSS feed, represented generally by reference numeral 112. The final example of an audit log alert rule that the audit log monitoring application 26 can be programmed to follow is to send a signal to deny a user's access to the protected health information when an abuse of protected health information is detected. The audit log monitoring application 26 can be programmed to deny a user access to protected health information for some or all possible abuses of protected health information that are detected.

The technical effect of the techniques described above is that important uses of protected health information are enabled, while the privacy of protected health information is protected from abuse. While only certain features of the invention have been illustrated and described herein, many modifications and changes will occur to those skilled in the art. It is, therefore, to be understood that the appended claims are intended to cover all such modifications and changes as fall within the true spirit of the invention.

1. A computer-implemented method of identifying an abuse of protected health information stored in an information system, comprising,
storing a record of each access to the protected health information in an information system operable to store a plurality of records of each access to the protected health information; and
identifying a possible unauthorized usage of protected health information by automatically sorting through the plurality of records of each access using sorting rules adapted to identify a possible unauthorized usage of protected health information.

2. The computer-implemented method as recited in claim 1, wherein a record of each access to the protected health information comprises:
a reference to the user accessing the protected health information; and
a reference to the patient corresponding to the protected health information.

3. The computer-implemented method as recited in claim 1, comprising:
blocking an authorized user's access to the protected health information when a possible unauthorized usage of a protected health information is identified.

4. The computer-implemented method as recited in claim 1, comprising:
communicating to an authority when a possible unauthorized usage of a protected health information is identified.

5. The computer-implemented method as recited in claim 1, comprising:
requiring a user to verify that they are an authorized user before allowing the user to access the protected health information.

6. The computer-implemented method as recited in claim 5, wherein the sorting rules are adapted to direct the information system to sort through the plurality of records of each access to identify each access to the protected health information of a designated patient.

7. The computer-implemented method as recited in claim 5, wherein the sorting rules are adapted to direct the information system to sort through the plurality of records of each access to identify each access to the protected health information of a designated patient by a designated user.

8. The computer-implemented method as recited in claim 2, wherein the record comprises a reference to the date and time that the protected health information was accessed.

9. The computer-implemented method as recited in claim 8, wherein the sorting rules are adapted to direct the information system to sort through the plurality of records of each access to identify each access to the protected health information after a defined period after normal working hours of a designated patient.

10. The computer-implemented method as recited in claim 8, wherein the sorting rules are adapted to direct the information system to sort through the plurality of records of each access to identify each access by two users to the same protected health information at the same time.

11. The computer-implemented method as recited in claim 2, wherein the record comprises a reference to the protected health information accessed.

12. The computer-implemented method as recited in claim 2, wherein the record comprises any search terms used by a user during a search of the protected health information.

13. A system for identifying an abuse of protected health information stored in an information system, comprising,
means for storing a record of each access to the protected health information in an information system operable to store a plurality of records of each access to the protected health information; and
means for identifying a possible unauthorized usage of protected health information by automatically sorting through the plurality of records of each access using sorting rules adapted to identify a possible unauthorized usage of protected health information.

14. A machine-readable medium for identifying an abuse of protected health information stored in an information system, comprising,
code operable to store a record of each access to the protected health information in an information system operable to store a plurality of records of each access to the protected health information; and
code operable to identify a possible unauthorized usage of protected health information by automatically sorting through the plurality of records of each access using sorting rules adapted to identify a possible unauthorized usage of protected health information.

15. A computer-implemented method of identifying abuse of protected health information stored in an information system, comprising,
data mining a plurality of records of access to the protected health information stored in the information system for evidence of an abuse of protected health information; and
identifying a record of access when evidence of an abuse of protected health information within the record of access is detected by the data mining of the plurality of records of access to the protected health information.

16. The computer-implemented method as recited in claim 15, wherein evidence of an abuse of protected health information is based on data mining rules adapted to identify possible abuses of protected health information.

17. The computer-implemented method as recited in claim 16, wherein the data mining rules are adapted to direct the information system to sort through data within each record of access by a user to identify behavioral patterns representative of an abuse of protected health information.

18. The computer-implemented method as recited in claim 17, comprising storing a record of each access to the protected health information in the information system.

19. The computer-implemented method as recited in claim 18, wherein a record of each access to the protected health information comprises:
a reference to the protected health information accessed;
a reference to the user accessing the protected health information;
a reference to the patient corresponding to the protected health information; and
a reference to the date and time that the protected health information was accessed.

20. The computer-implemented method as recited in claim 19, wherein the record of each access to the protected health information comprises a reference to a search term used to identify the protected health information accessed by a user.
